(19) United States
(12) Patent Application Publication
(10) Pub. No.: US 2013/0135077 A1
(43) Pub. Date: May 30, 2013

(54) RESONATOR AND WIRELESS POWER TRANSMISSION DEVICE

(71) Applicants: Tetsu SHIJO, Tokyo (JP); Akiko YAMADA, Yokohama-shi (JP); Shuichi OBAYASHI, Yokohama-shi (JP)

(72) Inventors: Tetsu SHIJO, Tokyo (JP); Akiko YAMADA, Yokohama-shi (JP); Shuichi OBAYASHI, Yokohama-shi (JP)

(73) Assignee: KABUSHIKI KAISHA TOSHIBA, Tokyo (JP)

(21) Appl. No.: 13/675,821

(22) Filed: Nov. 13, 2012

(30) Foreign Application Priority Data
Nov. 15, 2011 (JP) 2011-250086

(51) Int. Cl. H01F 27/00

(52) U.S. Cl. CPC H01F 27/00
USPC 336/221

(57) ABSTRACT

There is provided a resonator including a magnetic core and a coil wherein the magnetic core includes a first magnetic core block and a second magnetic core block, the coil is wound on the magnetic core, the first magnetic core block includes a first portion and second portions on sides of the first portion, a sectional area of the first portion is larger than each sectional area of the second portions, the second magnetic core block includes a third portion and fourth portions on sides of the third portion along its longitudinal direction, a sectional area of the third portion is larger than each sectional area of the fourth portions, and the coil is wound on the first portion and the third portion.

### CROSS REFERENCE TO RELATED APPLICATIONS

This application is based upon and claims the benefit of priority from the prior Japanese Patent Application No. 2011-250086, filed on Nov. 15, 2011, the entire contents of which are incorporated herein by reference.

### FIELD

Embodiments described herein relate generally to a resonator and a wireless power transmission device, and more particularly to a resonator using, e.g., a magnetic coil and to a wireless power transmission device using the resonator.

### BACKGROUND

In a conventional power transmission device, primary and secondary side resonators, which are substantially flat magnetic cores wound with coils, are disposed in a face-to-face relation in order to strengthen against positional shifts in right-and-left directions of a primary side coil and a secondary side coil. Such a problem, however, arises that a weight increases due to enlarged areas of the flat surfaces of the cores.

For obviating the defect about the weight, in the conventional wireless power transmission device, for reducing the weight, the cores of the respective coils involve using a plurality of cores disposed at an interval, and the primary side and the secondary side are set in the face-to-face relation. Lines of magnetic forces for compensating a core-to-core gap are output from the plurality of cores wound with coils, and therefore the primary side core and the secondary side core are configured to act as the cores having enlarged sizes including the core-to-core gap in dimensions thereof.

Magnetic fluxes are, however, concentrated most on the coil-wound portions of the cores at both of right and left ends in the plurality of cores. Hence, the dividing into the cores may raise a problem that sectional areas of the magnetic cores decrease, a degree of concentration declines and a core loss increases. The core loss increases for the reason that will be elucidated as below.

Generally, the core loss, i.e., the loss in the case of using a magnetic substance as the core in an AC magnetic field is classified into a hysteresis loss, an eddy-current loss and other residual losses. According to Steinmetz's empirical formula, the hysteresis loss is, if a magnetic flux density B is within a range of about 0.1-1 tesla, proportional to the magnetic flux density B raised to the power of 1.6. Further, the eddy-current loss is proportional to the magnetic flux density B raised to the power of 2. Incidentally, it is known that other residual losses augment at a frequency of about MHz or higher. Accordingly, in the case of using the frequency of, e.g., 1 MHz or lower, other residual losses can be approximated as being well smaller than the hysteresis loss and the eddy-current loss.

In this case, for example, if the sectional area of the core is halved and if approximated to no variation in magnetic flux passing through the core, the magnetic flux density increases twice, and hence the core loss per unit sectional area rises about 2.56-fold to 4-fold. Even when considered in terms of the core loss of the whole cores and if the sectional area of the core is halved, the cores loss can be presumed to increase about 1.28-fold to 2-fold. To take into consideration an effect yielded when the magnetic fluxes are concentrated most on the coil-wound portions of the cores at both of the right-and-left ends in the plurality of cores, it is predicted that the core loss will further increase. In addition, if the increased magnetic flux density reaches a value high enough to cause magnetic saturation of the magnetic substance, a problem is that the effect of the magnetic substance abruptly disappears and an inductance of the resonator sharply decreases.

Further, if the coil is wound up to portions vicinal to the upper and lower ends of the core, equivalent magnetic permeability decreases to a great degree in positions vicinal to the upper and lower ends due to diamagnetism, and therefore such a problem exists that the inductance of the coil gets hard to rise. Moreover, the portions wound with none of windings in the magnetic core blocks taking a face-to-face relation are shortened, and hence there is such a problem that a path of a magnetic flux loop is shortened to reduce coupling.

On the other hand, in another conventional wireless power transmission device, coil blocks are arranged in an H-shape in order to improve the coupling coefficient between the primary side coil and the secondary side coil. In this case also, however, the areas of the coil blocks are enlarged, resulting in a problem that the weight increases.

Thus, the conventional wireless power transmission devices have the problem that the weight of the resonator wound with the coil by use of the substantially flat magnetic core becomes heavy. Furthermore, if using the plurality of cores disposed at the interval for reducing the weight, the magnetic fluxes are concentrated most on the coil-wound portions in the cores at both of the right-and-left ends, and hence such a problem exists that the degree of concentration declines and the core loss rises. Moreover, in the case of winding the coils up to the portions vicinal to the upper and lower ends of the cores, the equivalent magnetic permeability decreases to the great degree in the positions vicinal to the upper and lower ends due to the diamagnetism, and therefore such a problem exists that the inductance of the coil gets hard to rise.

There are given other problems such as downsizing the device, lowering the loss, reducing a thickness of the device, reducing a weight of the whole device, simplifying a heat radiation mechanism, increasing electric power and reducing the loss.

### BRIEF DESCRIPTION OF THE DRAWINGS

FIG. 1 illustrates a resonator according to a first embodiment.

FIG. 2 shows an example of a layout in the case of applying the resonator illustrated in FIG. 1 to a primary side resonator and a secondary side resonator of a wireless power transmission device.

FIG. 3 shows a block diagram of the wireless power transmission device using the resonator illustrated in FIG. 1.

FIG. 4 illustrates a configuration of reducing thicknesses of upper and lower ends of magnetic core blocks.

FIG. 5 shows a layout in the case of applying the resonator in FIG. 4 to the primary side resonator and the secondary side resonator.

FIG. 6 shows an example in which widths of coil-wound portions are enlarged outward on the right and left sides of the coils as compared with other portions.

FIG. 7 shows an example in which the widths of the coil-wound portions are enlarged on both of the right and left sides of the coils as compared with other portions.

FIG. 8 shows an example in which coil-wound portions are enlarged inward on the right and left sides, while portions wound with none of the coil have their widths getting narrower in a tapered shape on a step-by-step basis toward the upper and lower ends.

FIG. 9 shows an example in which the coil-wound portions are enlarged outward on the right and left sides of the coil, while the portions wound with none of the coil have their widths getting narrower in the tapered shape on the step-by-step basis toward the upper and lower ends.

FIG. 10 shows an example in which the coil-wound portions are enlarged on both of the right and left sides of the coil, while the portions wound with none of the coil have their widths getting narrower in the tapered shape on the step-by-step basis toward the upper and lower ends.

FIG. 11 illustrates an example in which thicknesses of coil-wound portions are changed in comparison with other portions stepwise at two stages.

FIG. 12 illustrates an example in which the thicknesses of coil-wound portions are changed in comparison with other portions stepwise at three stages.

FIG. 13 illustrates an example of making a change to the configuration in asymmetry with respect to the upper and lower portions in the case of changing the thicknesses of the coil-wound portions stepwise at the three stages in comparison with other portions.

FIG. 14 shows an example of a configuration of setting a plurality of locations wound with the coils.

FIG. 15 shows an example of varying the widths of outward portions wound with none of the coil in a tapered shape so as to get narrower on the step-by-step basis toward the upper and lower ends of the core blocks in the right-and-left magnetic core blocks.

FIG. 16 illustrates an example of concentrating the coil-wound portions on a portion having a specified length at a central portion.

FIG. 17 shows an example of adding fins to the right-and-left magnetic core blocks.

FIG. 18 shows an example of adding the fins in directions different from those in FIG. 17.

FIG. 19 illustrates an example of a configuration of concentrating the coil-wound portions on the portion having the specified length at a central portion and changing a shape in a thicknesswise direction.

FIG. 20 illustrates another example of the configuration of concentrating the coil-wound portions on the portion having the specified length at a central portion and changing the shape in the thicknesswise direction.

FIG. 21 shows an increase effect of a coupling coefficient based on the configuration in FIG. 19.

FIG. 22 shows the increase effect of the coupling coefficient based on the configuration in FIG. 20.

FIG. 23 shows an example in which a section of the coil is elliptical.

FIG. 24 shows an example of disposing the core blocks at portions exhibiting the largest curvature of the coil.

FIG. 25 is a first explanatory diagram of a reactance increase effect owing to an addition of a third magnetic core block.

FIG. 26 is a second explanatory diagram of the reactance increase effect owing to the addition of the third magnetic core block.

FIG. 27 is a third explanatory diagram of the reactance increase effect owing to the addition of the third magnetic core block.

FIG. 28 shows an example of the configuration of adding the third magnetic core block.

FIG. 29 shows a magnetic field intensity profile when adding the third magnetic core block.

FIG. 30 shows an example of integrating the portions having broad sectional areas of the respective magnetic core blocks.

FIG. 31 shows another example of integrating the portions having broad sectional areas of the respective magnetic core blocks.

FIG. 32 shows one example of dimensions of the resonator.

FIG. 33 shows a graph of a relation between positional shifts of the primary and secondary side resonators and a coupling coefficient k.

FIG. 34 shows an example of elongating the magnetic core block.

FIG. 35 shows a graph of a relation between the positional shifts of the primary and secondary side resonators and the coupling coefficient in the case of the configuration in FIG. 34.

FIG. 36 shows an example of taking different values as lengths of the two magnetic core blocks.

FIG. 37 shows a graph of the relation between the positional shifts of the primary and secondary side resonators and the coupling coefficient in the case of the configuration in FIG. 36.

FIG. 38 shows an example of adding the fin to the magnetic core block that is shorter in total length.

FIG. 39 shows another example of adding the fin to the magnetic core block that is shorter in total length.

FIG. 40 shows a first example of setting values different from each other as the total lengths of at least the two magnetic core blocks among the three magnetic core blocks.

FIG. 41 shows a second example of setting the values different from each other as the total lengths of at least the two magnetic core blocks among the three magnetic core blocks.

FIG. 42 shows a third example of setting the values different from each other as the total lengths of at least the two magnetic core blocks among the three magnetic core blocks.

FIG. 43 illustrates how a distance between the two magnetic core blocks is changed.

FIG. 44 illustrates a graph of fluctuations in inductance when changing the distance between the two magnetic core blocks.

FIG. 45 shows a magnetic flux density profile inside the magnetic core block in the case of using a conventional resonator.

FIG. 46 shows the magnetic flux density profile inside the magnetic core block in the case of using the resonator illustrated in FIG. 1.

FIG. 47 shows the magnetic flux density profile inside the magnetic core block in the case of using the resonator illustrated in FIG. 28.

### DETAILED DESCRIPTION

According to an embodiment, there is provided a resonator including a magnetic core and a coil.

The magnetic core includes a first magnetic core block and a second magnetic core block. The second magnetic core block is disposed at an interval from the first magnetic core block.

The coil is wound on the magnetic core in a lateral direction of the first and second magnetic core blocks.

The first magnetic core block includes a first portion and second portions on sides of the first portion along a longitudinal direction of the first magnetic core block. A sectional area of the first portion is larger than each sectional area of the second portions in a direction orthogonal to the longitudinal direction of the first magnetic core block.

The second magnetic core block includes a third portion and fourth portions on sides of the third portion along the longitudinal direction of the second magnetic core block. A sectional area of the third portion is larger than each sectional area of the fourth portions in a direction orthogonal to the longitudinal direction of the second magnetic core block.

The coil is wound on the first portion of the first magnetic core block and the third portion of the second magnetic core block.

Hereinafter, embodiments will be described in detail with reference to the accompanying drawings.

FIG. 1 illustrates a resonator used for a wireless power transmission device in a first embodiment. FIG. 1(A) is a top view; FIG. 1(B) is a side view as viewed from under along the sheet surface; and FIG. 1(C) is a side view as viewed from right side along the sheet surface.

This resonator includes a coil 11 and a magnetic core including magnetic core blocks 12, 13. The coil 11 is a coil that is flat on the whole and has side sections including two portions with curvatures larger than those of other portions. Lines of magnetic forces are concentrated on the portions having the larger curvatures, and in FIG. 1 these two portions having the larger curvatures are positioned at both of right-and-left ends.

At least two pieces of magnetic core blocks, i.e., the magnetic core block (the first magnetic core block) 12 and another magnetic core block (the second magnetic core block) 13, are disposed to penetrate inside the coil 11. The coil 11 is wound on the magnetic core in lateral directions of the magnetic core blocks 12, 13. The magnetic core blocks 12, 13 are made proximal to both of right-and-left ends inwardly of the coil 11.

The magnetic core block 12 includes a first portion 12A and second portions 12B, 12B provided on both ends of the first portion 12A along a longitudinal direction of the magnetic core block 12. In a direction orthogonal to the longitudinal direction, a sectional area of the first portion 12A is larger than that of the second portion 12B. Note that the longitudinal direction coincides with the direction in which the hole of the coil penetrates.

The magnetic core block 13 includes a third portion 13A and fourth portions 13B, 13B provided on both ends of the third portion 13A along the longitudinal direction of the magnetic core block 13. In the direction orthogonal to the longitudinal direction, a sectional area of the third portion 13A is larger than that of the fourth portion 13B.

The coil 11 is wound on the portions each having the large sectional area, i.e., wound on the first portion 12A and the third portion 13A. The thickness of each of the magnetic core blocks 12, 13 is fixed, and a width LA of each of the first portion 12A and the third portion 13A is set larger than a width LB of each of the second portion 12B and the fourth portion 13B. Namely, the sectional area is expanded by enlarging the width, while fixing the thickness. The thickness is fixed, thereby enabling the thicknesses of the magnetic core blocks to be uniformed and the resonator to be thinned.

The resonator being thus configured, there are enlarged the sectional areas of the coil-wound portions on which the magnetic fluxes are concentrated most, a core loss is reduced, and a quantity of the magnetic substance other than the coil-wound portions is reduced to a great degree, thus enabling a weight to be decreased.

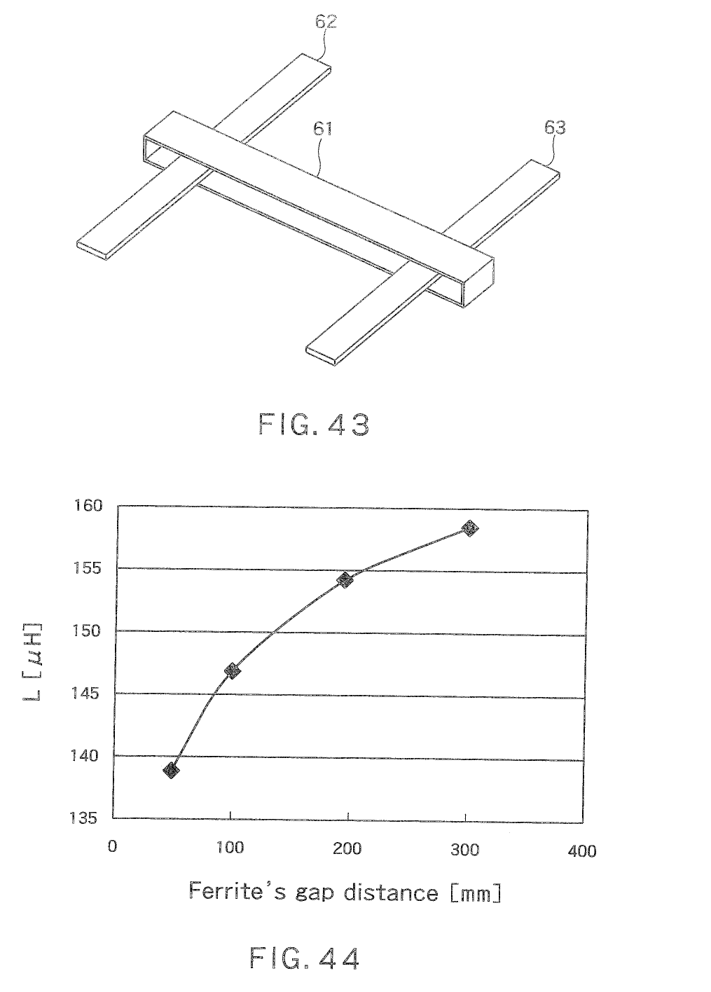

FIG. 44 shows a graph indicating fluctuations in inductance when varying a distance between the two magnetic core blocks 62, 63 with respect to the flat resonator illustrated in FIG. 43. A larger inductance value can be obtained because of the magnetic substance exerting a large influence when positioned at both of right-and-left ends, which corresponds to the rightmost side in the graph.

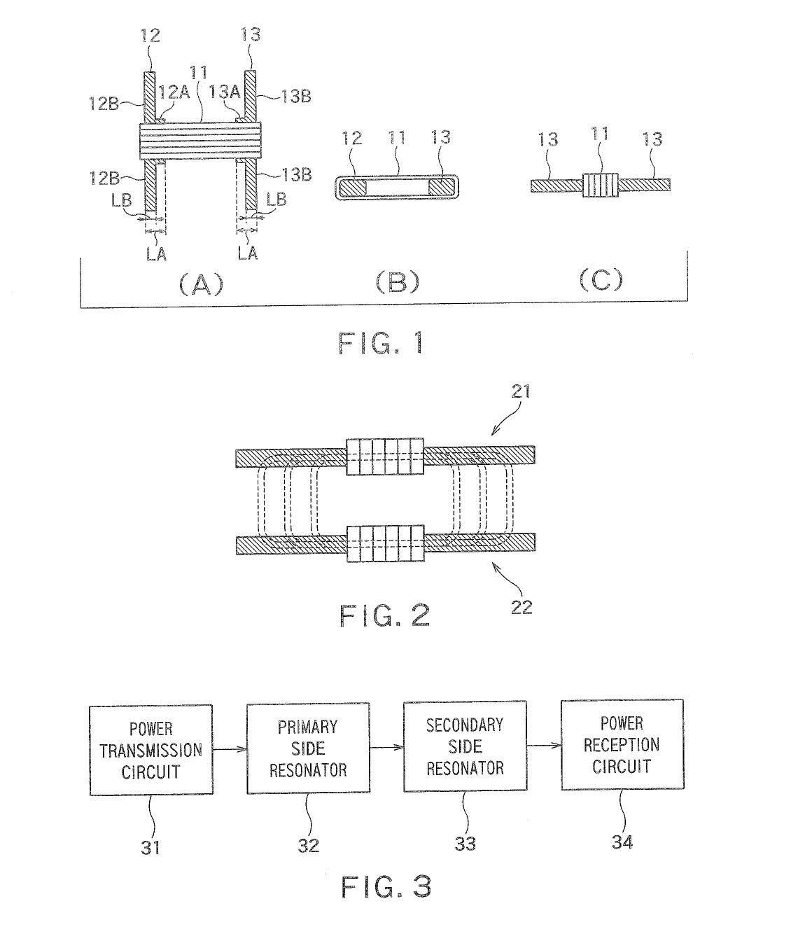

FIG. 2 is a side view depicting a layout example in a case where the resonator illustrated in FIG. 1 is applied to a primary side resonator 21 and a secondary side resonator 22 of the wireless power transmission device.

The primary side resonator and the secondary side resonator are disposed in a face-to-face relation. The portions with none of windings in the magnetic core blocks having a vertical face-to-face relation become more elongate than in one example of the prior art (the core wound with the coil from the vicinity of the upper end down to the vicinity of the lower end), and hence a longer path of a magnetic flux loop can be ensured to enable vertical coupling to be increased.

Further, as compared with this one example of the prior art, the portions wound with the coils are concentrated at the central portions in the present embodiment. In particular, a length extending from the upper end of the coil-wound portion to the lower end of the coil-wound portion is set equal to or smaller than ⅓ of a length L_core of the magnetic core block. Generally, in the case of being used in a state of the magnetic path not being closed as in the core blocks of both the resonators in FIG. 2 (to given a comparative example, for instance, by way of one example of a transformer, the core takes a looped shape and, in this case, it can be said that the magnetic path is closed), an equivalent magnetic permeability exhibiting an actual effect largely decreases against a primary magnetic permeability retained by the magnetic substance as it gets distanced from the center with respect to the lengthwise direction of the core due to an influence of diamagnetism. As in the present working example, the coil is wound on the portions much closer to the center, the equivalent magnetic permeability becomes even larger, and hence, in the case of wiring the coil having the same length, such an effect is yielded that the still higher inductance value can be obtained. Namely, it is feasible to augment the coupling between the resonators and to restrain the equivalent magnetic permeability of the portions wound with the coil from decreasing due to the diamagnetism.

FIG. 3 shows a block diagram of the wireless power transmission device in the first embodiment, which uses the resonator illustrated in FIG. 1. A power transmission circuit 31 supplies a primary side resonator 32 with a power signal of a frequency which enables efficient transmission. The power signal is wirelessly transmitted owing to the coupling between the primary side resonator 32 and the secondary side resonator 32. The power signal received by the secondary side resonator 32 is transmitted to a power reception circuit 34. Note that a control unit of the power transmission circuit 31 and a control unit of the power reception circuit 34 perform communications with each other by use of wireless signals between the power transmission circuit 31 and the power reception circuit 34 as the necessity arises, thereby starting, finishing and stopping the transmission and the reception of the power and changing an electric energy of the power transmission.

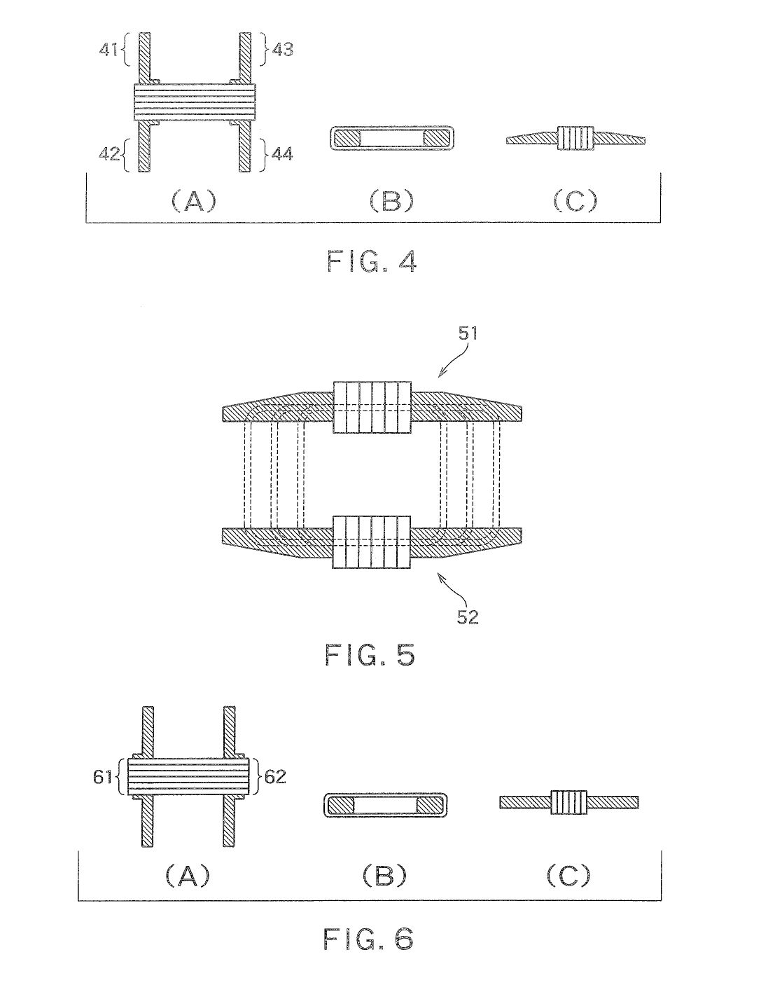

As depicted in FIG. 4, it can be also considered that the weight is reduced by decreasing thicknesses of upper ends 41, 43 and lower ends 42, 44 of the right-and-left magnetic core blocks. FIG. 4(A) is a top view; FIG. 4(B) is a side view as viewed from under along the sheet surface; and FIG. 4(C) is a side view as viewed from right side along the sheet surface.

FIG. 5 illustrates a layout in a case where the resonator illustrated in FIG. 4 is applied to a primary side resonator 51 and a secondary side resonator 52. As in FIG. 5, the coupling of the magnetic fluxes between the resonators occurs at the upper and lower ends of the magnetic core blocks, and hence a density of the intra-core magnetic fluxes thereat decreases as compared with the central portion, and such a possibility is small that magnetic saturation is caused even when reducing the thickness. Incidentally, as shown in FIG. 5, it can be also considered that the coupling between the resonators is further enhanced by setting both the resonators in the face-to-face relation in a way that decreases the thicknesses in asymmetry with respect to the upper and lower portions to make the upper and lower ends of the cores close to each other.

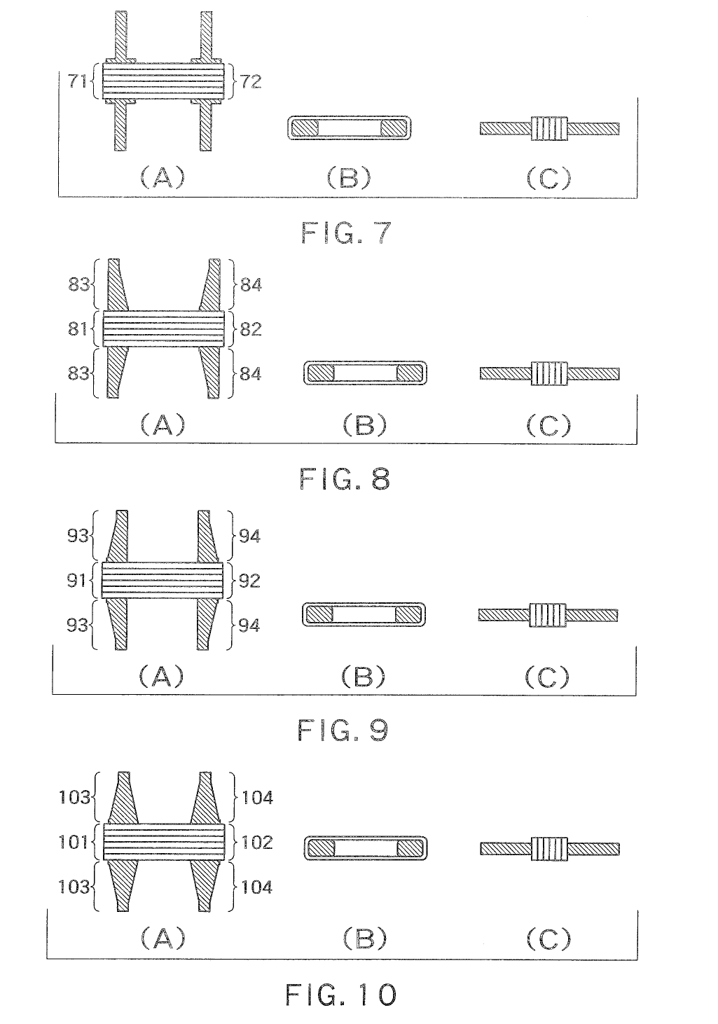

Note that in the case of setting the width of the portion wound with the coil larger than those of other portions in the configuration of the right-and-left magnetic core blocks, configurations depicted in FIGS. 6 and 7 are also considered available other than the configuration in FIG. 1.

In FIG. 6, the width of each of portions 61, 62 wound with the coil is set larger outward on the right and left sides of the coil than those of other portions.

In FIG. 7, the width of each of portions 71, 72 wound with the coil is set larger on both of the right and left sides of the coil than those of other portions.

Further, as in FIG. 8, portions 81, 82 wound with the coil may be enlarged inward on the right and left sides, while portions 83, 84 wound with none of the coil may have their widths getting narrower in a tapered shape on a step-by-step basis toward the upper and lower ends.

Alternatively, as in FIG. 9, portions 91, 92 wound with the coil may be enlarged outward on the right and left sides of the coil, while portions 93, 94 wound with none of the coil may have their widths getting narrower in the tapered shape on the step-by-step basis toward the upper and lower ends.

Still alternatively, as in FIG. 10, portions 101, 102 wound with the coil may be enlarged on both of the right and left sides of the coil, while portions 103, 104 wound with none of the coil may have their widths getting narrower in the tapered shape on the step-by-step basis toward the upper and lower ends.

In the examples illustrated in FIGS. 8 to 10, taper curves can be also considered to take other shapes in terms of manufacturing circumstances, etc.

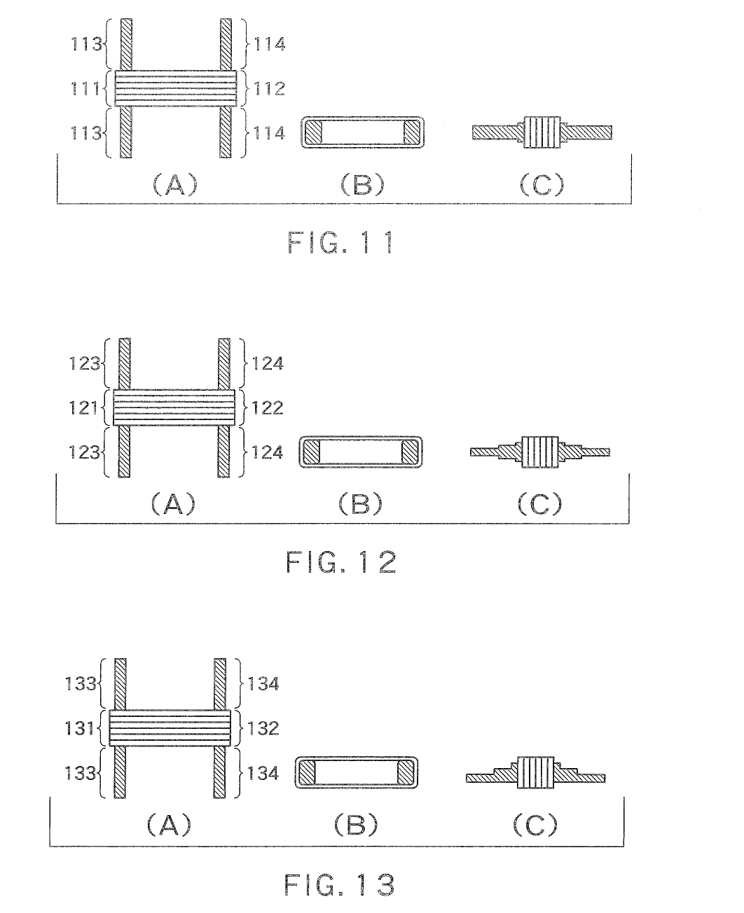

Note that in the configuration of the right-and-left magnetic core blocks, the portions wound with the coil have their thicknesses larger than those of other portions, thereby expanding, it can be considered, the sectional area of the portion on which the magnetic fluxes are concentrated most. FIGS. 11 to 13 illustrate these examples.

FIG. 11 illustrates an example in which the thicknesses of portions 111, 112 wound with the coil are changed in comparison with other portions 113, 114 stepwise at two stages.

FIG. 12 depicts an example in which the thicknesses of portions 121, 122 wound with the coil are changed in comparison with other portions 123, 124 stepwise at three stages.

FIG. 13 illustrates, in the case of changing the thicknesses of portions 131, 132 wound with the coil in comparison with other portions 133, 134 stepwise at the three stages, an example of making a change to the configuration in asymmetry with respect to the upper and lower portions. As a matter of course, as shown in FIG. 4, any inconvenience may not be caused by making a change to the tapered shape.

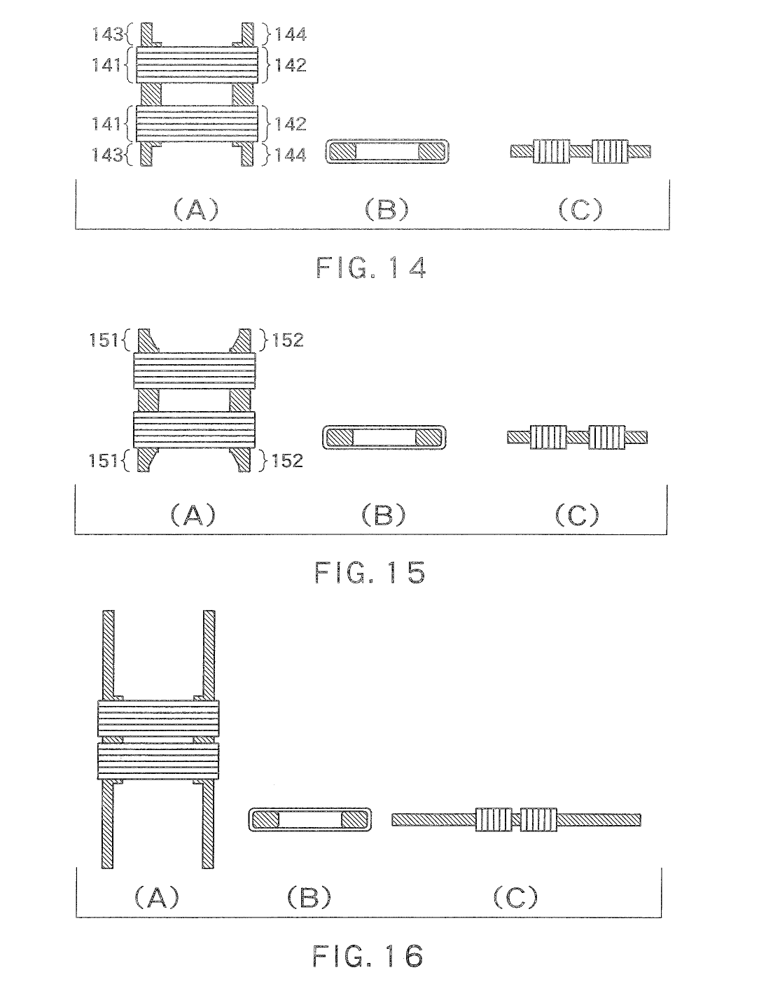

Moreover, in the case of causing the large electric power to flow, as in FIG. 14, it can be considered to disperse locations (portions) in which a temperature rises by providing a plurality of locations (portions) wound with the coil. In this case also, as depicted in FIG. 14, in the configuration of the right-and-left magnetic core blocks, the widths of portions 141, 142 wound with the coil are set larger than those of other portions 143, 144. With this contrivance, there are enlarged the sectional areas of the portions on which the magnetic fluxes are concentrated most, the core loss is reduced, and the quantity of the magnetic substance other than the coil-wound portions is reduced, thus enabling the weight to be decreased. Note that a portion between the coil-wound portions is the portion on which the magnetic flux is concentrated most, and therefore its sectional area is taken broad similarly to the coil-wound portion.

As in FIG. 15, in the right-and-left magnetic core blocks, it can be considered that widths of outward portions 151, 152 wound with none of the coil are varied in the tapered shape so as to get narrower on the step-by-step basis toward the upper and lower ends of the core blocks.

Further, as in FIG. 16, also in the case of providing the locations wound with the coil, the coil-wound portions may be concentrated at the central portion so that the length extending from the upper end of the coil-wound portion to the lower end of the coil-wound portion is set equal to or smaller than ⅓ of the length L_core of the magnetic core block. With this contrivance, similarly to the working example in FIG. 2, the equivalent magnetic permeability becomes much larger, and it is therefore feasible to obtain the sill higher inductance in the case of winding the coil having the same length.

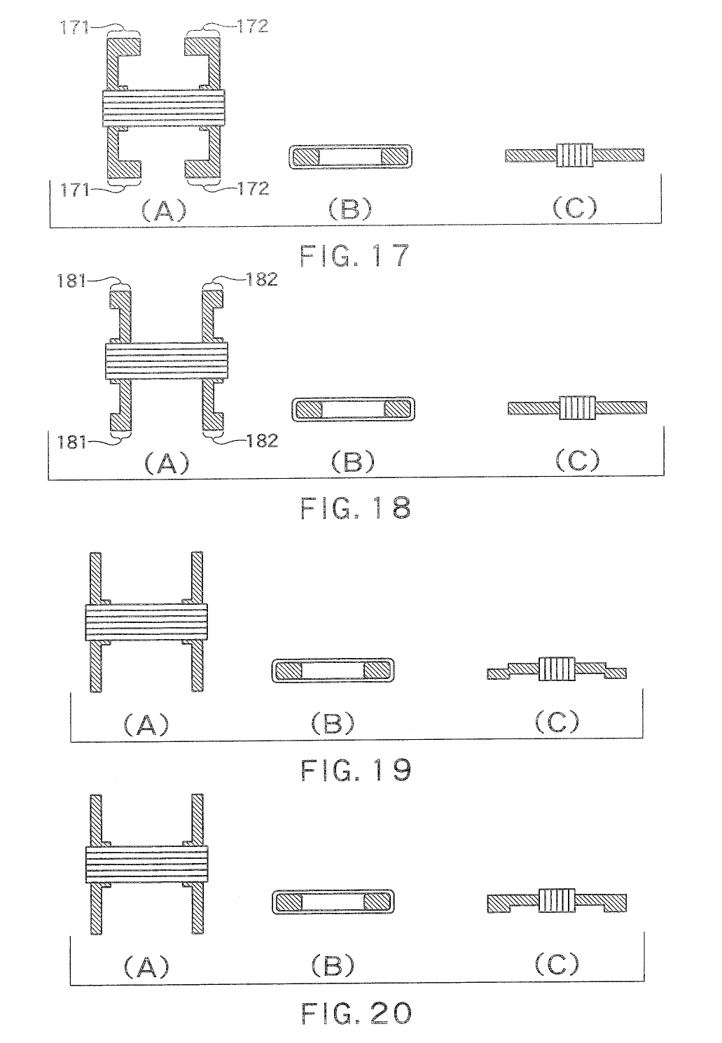

Furthermore, as illustrated in FIG. 17, it can be also considered that a configuration of the magnetic cores is changed by adding fins (extended portions) 171, 172 to the right-and-left magnetic core blocks, and the path of the magnetic flux loop is ensured further long by further elongating the portions having no windings in the magnetic core blocks taking the face-to-face relation, thereby further increasing a coupling coefficient between the resonators set in the face-to-face relation. Note that a fin adding mode is not limited to the mode in FIG. 17, and, as depicted in FIG. 18, fins 181, 182 may be added in directions different from those in FIG. 17.

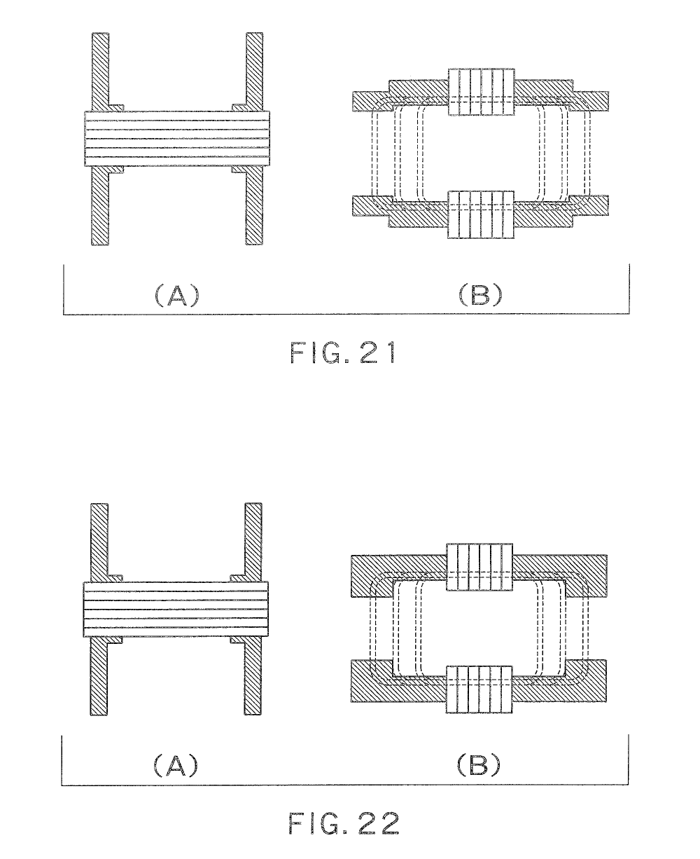

Moreover, FIGS. 19 and 20 show an example of a configuration in which the shape is changed in a thicknesswise direction while being kept so that the length extending from the upper end of the coil-wound portion to the lower end of the coil-wound portion is set equal to or smaller than ⅓ of the length L_core of the magnetic core block with respect to the right-and-left magnetic core blocks in the working example of FIG. 1. With this configuration, as depicted in FIGS. 21 and 22, it can be also considered to reduce a distance between some portions of the magnetic core blocks building up both the resonators and to further increase the coupling coefficient of the upper and lower resonators. The configuration in FIG. 20 can be also viewed as a configuration of adding the fins (extended portions) in the direction (thicknesswise direction) different from the direction (widthwise direction) in FIG. 17 or 18.

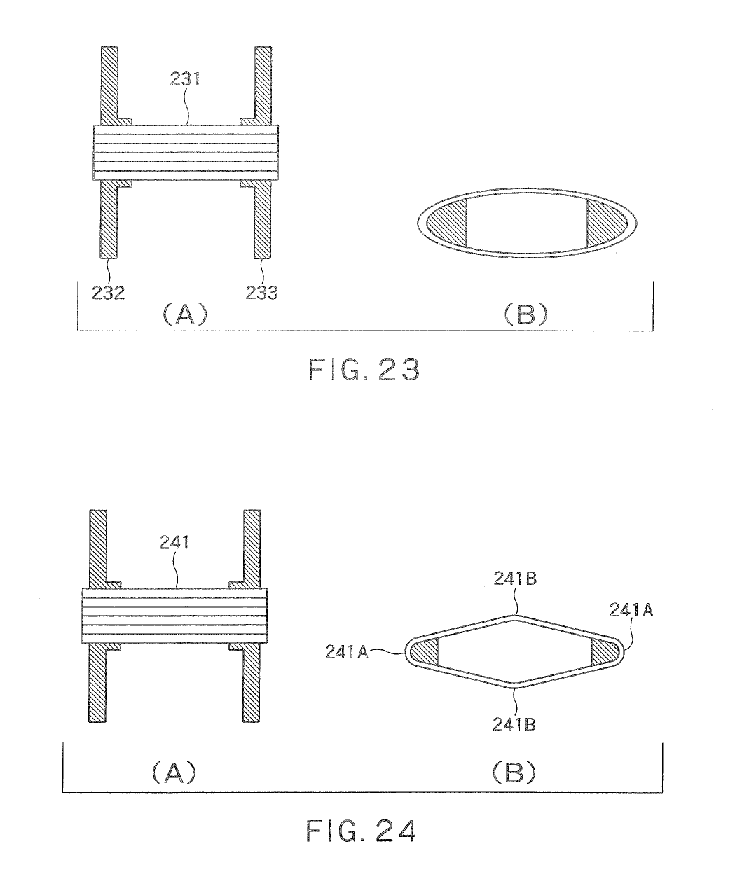

Note that even when the section of a coil 231 is not flat on the whole but elliptical as in FIG. 23, it can be considered that core blocks 232, 232 are disposed at these two portions because the elliptical includes at least two portions each exhibiting the large curvature.

Alternatively, as in FIG. 24, it can be considered that a coil 241 has portions 241A of a bending angle that is smaller than a bending angle of each of other two portions 242B having a large curvature, in which case the core blocks are disposed at the two portions 241A each having the small bending angle.

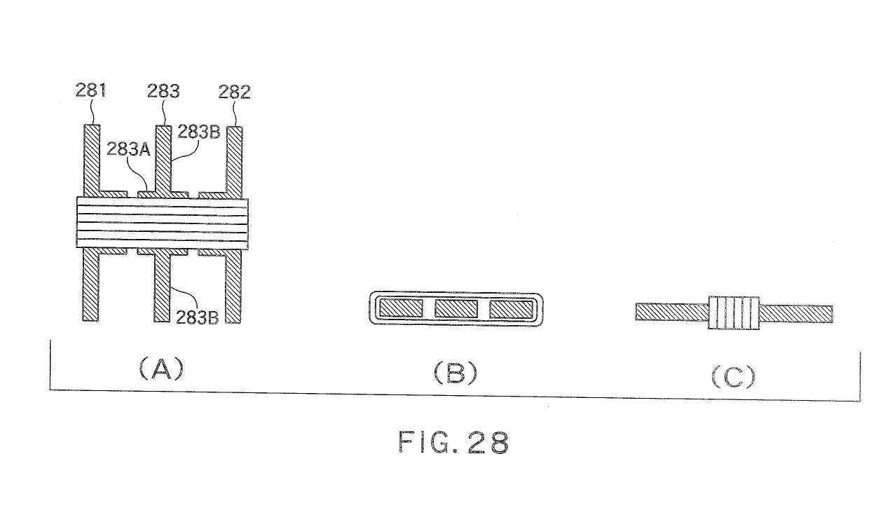

Moreover, such a configuration is also available that the magnetic core block is added to a portion including the center in the right-and-left directions of the coil. FIG. 28 shows an example of the configuration in this case. As in the working example of FIG. 1, in addition to magnetic core blocks 281, 282 disposed at both ends in the right-and-left directions of the coil, a magnetic core block (a third magnetic core block) 283 is added to the vicinity of the center of the coil. The magnetic core block 283 includes a fifth portion 283A and sixth portions 283B, 283B provided at both ends thereof along the longitudinal direction of the magnetic core block 283. In the direction orthogonal to the longitudinal direction, the sectional area of the fifth portion 283A is larger than that of the sixth portion 283B. The coil is wound on the fifth portion 283A having the larger sectional area. Note that the fins (the extended portions) described above may also be added to the end portions of the respective sixth portions 283B. Given hereinafter is a description of the contrivance that the sectional area of the coil-wound portion of the magnetic core block 283 is set broader than other portions similarly to the magnetic core blocks 281, 282.

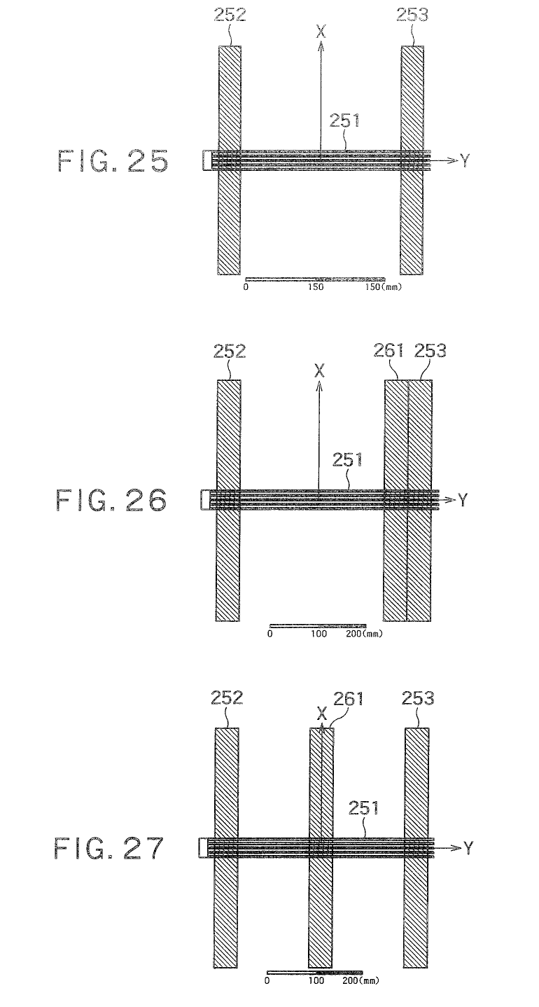

For example, according to a calculation, a coil reactance value of a coil 251 illustrated in FIG. 25, of which only both ends are provided with magnetic core blocks 252, 253, is 23 μH, in which case an assumption is that an additional rod-like magnetic core block 261 shown in FIG. 26 is placed in a side-by-side relation with the magnetic core block 253 disposed at the lateral end. In this case, the reactance value is 26.5 μH, and, by contrast, if the rod-like magnetic core block 261 is added to the middle of the coil 251 as in FIG. 27, the reactance value comes to 29.4 μH.

Accordingly, with respect to the resonator in FIG. 27, the width of the coil-wound portion is set further larger than those of other portions in the shapes of the respective magnetic core blocks 281, 282, 283 as in FIG. 28 in the same way as done in the first embodiment. With this contrivance, there are enlarged the sectional are of the portion on which the magnetic fluxes are concentrated most and the sectional area of the portion exhibiting the second highest concentration of the magnetic fluxes, the core loss is reduced, and the quantity of the magnetic substance other than these portions is reduced to the great degree, thus enabling the weight to be decreased. That is, the third magnetic core block is disposed at the portion including the center that exhibits a large effect of the increase in inductance of the coil next to the portions vicinal to the both of the right-and-left ends, and there is enlarged the sectional area of the portion on which the magnetic fluxes are concentrated most in the third magnetic core block, the core loss is thereby decreased, and the quantity of the magnetic substance other than these portions is largely reduced, whereby the weight can be reduced.

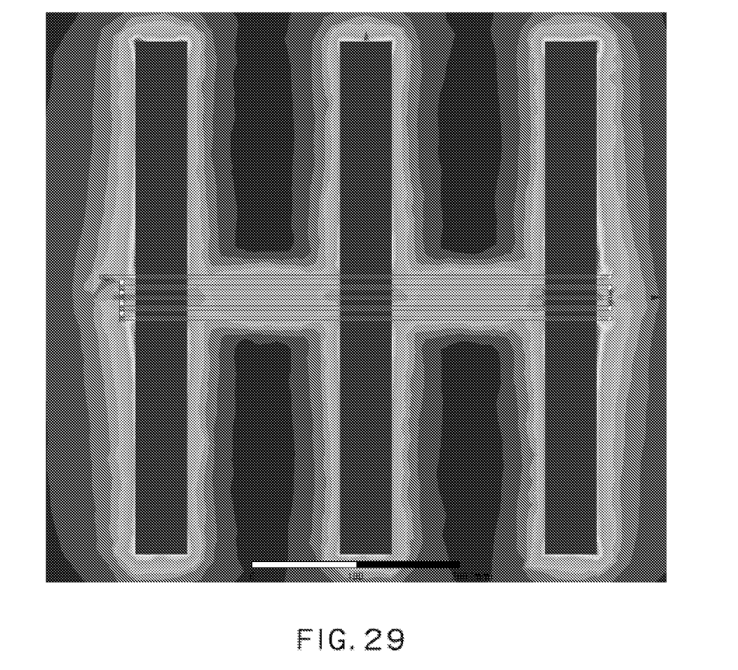

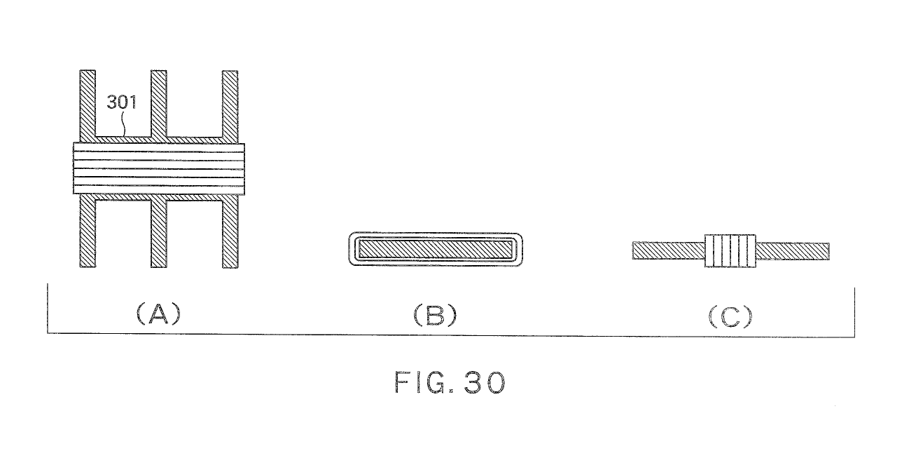

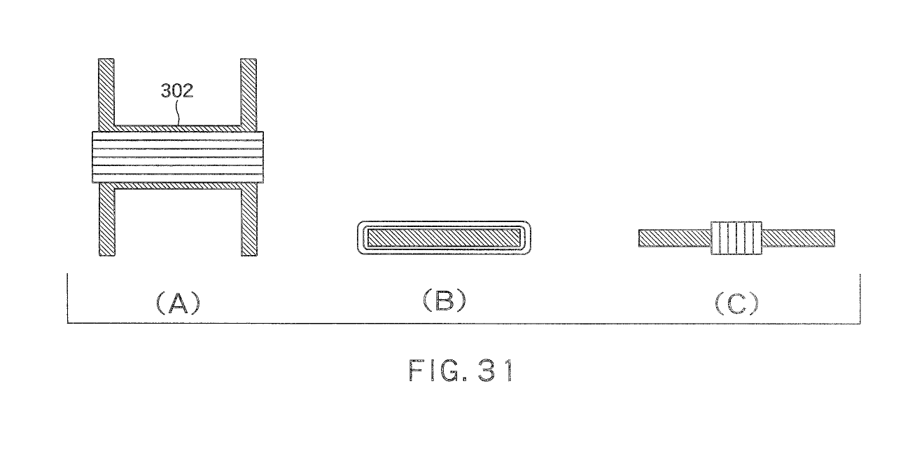

Incidentally, an addition to an idea of FIG. 28, in a magnetic field profile about the coil in the case of additionally installing the rod-like magnetic core block, there increases an intensity of a magnetic field in close proximity to the lines forming coil as indicated by the calculation result in FIG. 29. By making use of this point, it can be considered that the magnetic core blocks 301, 302 are installed in close proximity to the lines of coil as in FIGS. 30 and 31. The configuration in FIGS. 30 and 31 can be grasped as a configuration of integrating the portions, having the large sectional areas, of the respective magnetic core blocks. These magnetic core blocks installed in close proximity to the lines of coil have, even when taking a shape exhibiting a small effect of the diamagnetism, a large effect because of being placed in the locations with the strong magnetic field and can increase the reactance value. Further, the magnetic core block taking the short shape is disposed in the proximity to the magnetic core block taking the elongate shape, thereby having effects in relaxing the concentration of the magnetic fluxes in the magnetic core block taking the elongate shape and reducing the magnetic saturation and the core loss as well.

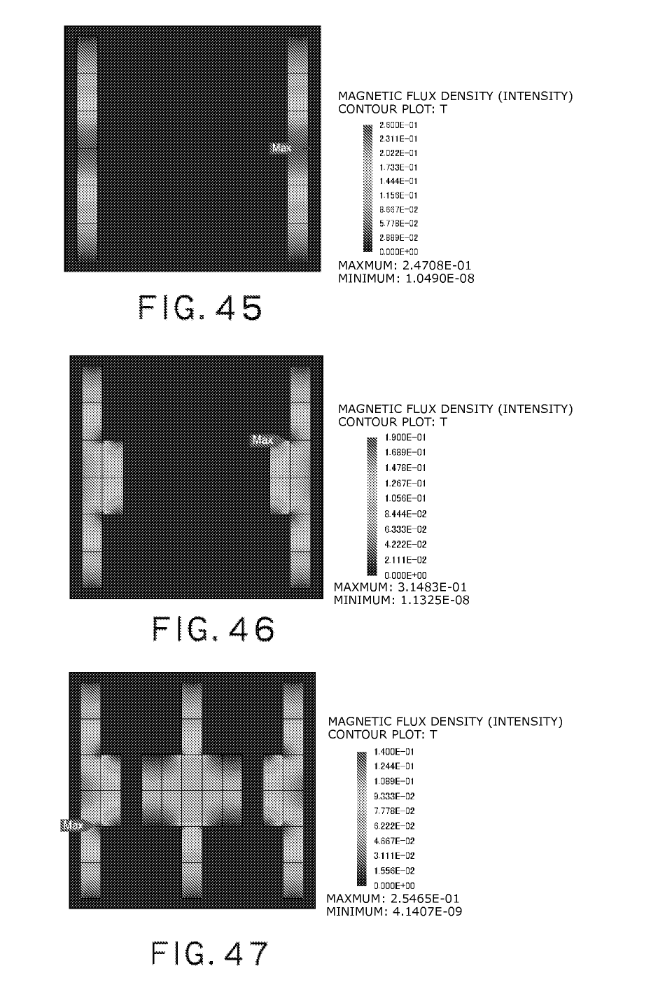

FIGS. 45, 46 and 47 show the densities of the magnetic fluxes inside the magnetic substance, which are obtained by numerical calculations, with respect to the resonator using the conventional magnetic core blocks disclosed in Patent document 1, the resonator in the first embodiment illustrated in FIG. 1 and the resonator given by way of one example of the embodiment of the present invention depicted in FIG. 28. As described above, as seen in FIG. 45, in the conventional magnetic core block, the density of the magnetic fluxes of the coil-wound portion at the central portion in the long-side direction rises over the whole width of the core. By contrast with this, in the case of the resonator in FIG. 1, as illustrated in FIG. 46, though the density of the magnetic fluxes becomes large at a locally recessed point of one some portion, there decreases the density of the magnetic fluxes of the coil-wound portion at the central portion in the long-side direction. Further, in the case of the resonator in FIG. 28, as illustrated in FIG. 47, though the density of the magnetic fluxes still becomes large at the locally recessed point of one some portion, there further decreases the density of the magnetic fluxes of the coil-wound portion at the central portion in the long-side direction. Note that the local rise in density of the magnetic fluxes as seen in FIGS. 46 and 47 is confined to a narrow area of one some portion but is not so large, and hence a ratio at which the loss at this portion occupies a (total) loss of the whole magnetic core blocks is extremely small.

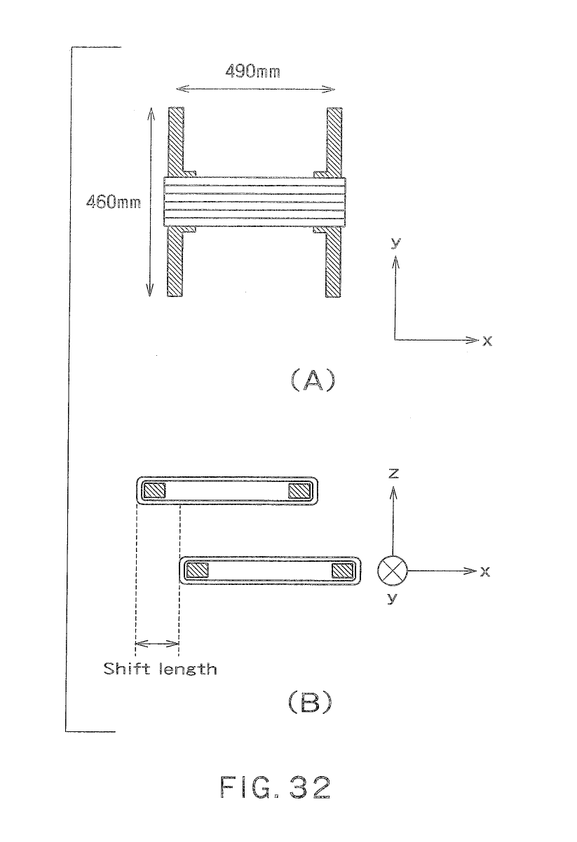

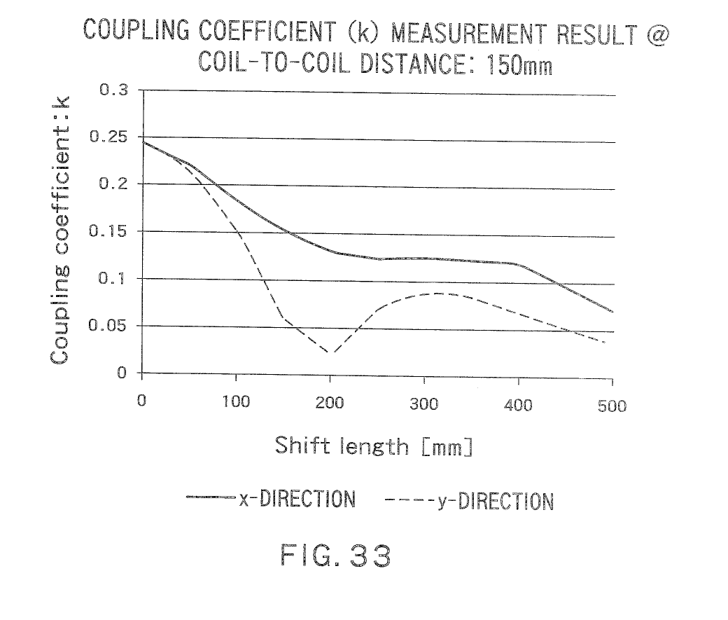

FIG. 32(A) shows dimensions of the resonator manufactured on an experimental basis by way of one example of the embodiment of the present invention. FIG. 32(B) shows a side view representing a positional relation between the two resonators. A direction parallel to the windings is set as the x-axis, while a direction vertical thereto is set as the y-axis. FIG. 33 shows a result of measuring the coupling coefficient when shifted in x- and y-directions.

An inter-coil efficiency depends on a product (k×Q) of k and Q, and, in the case of using the resonator with Q=196, a relation such as the inter-coil efficiency >90% is obtained when the coupling coefficient k>0.1.

When roughly targeted at the coupling coefficient k=0.1, an allowable range of the positional shift is up to 420 mm in the x-direction and up to 120 mm in the y-direction.

In the case of the dimensions shown in FIG. 32, the allowable range of the positional shift in the x- and y-directions shows a 3-fold or larger difference with unbalance.

A reason why the allowable range of the positional shift in the y-direction is small is that there exists a point at which a total sum of the magnetic fluxes penetrating the secondary side coil becomes “0”. As illustrated in FIG. 33, when the positional shift in the y-direction is 200 mm, the coupling coefficient decreases due to cancellation of magnetic fluxes. This decrease is equivalent to 43% of the y-directional dimension.

The coupling characteristic depends on the dimensions of an external shape of the resonator.

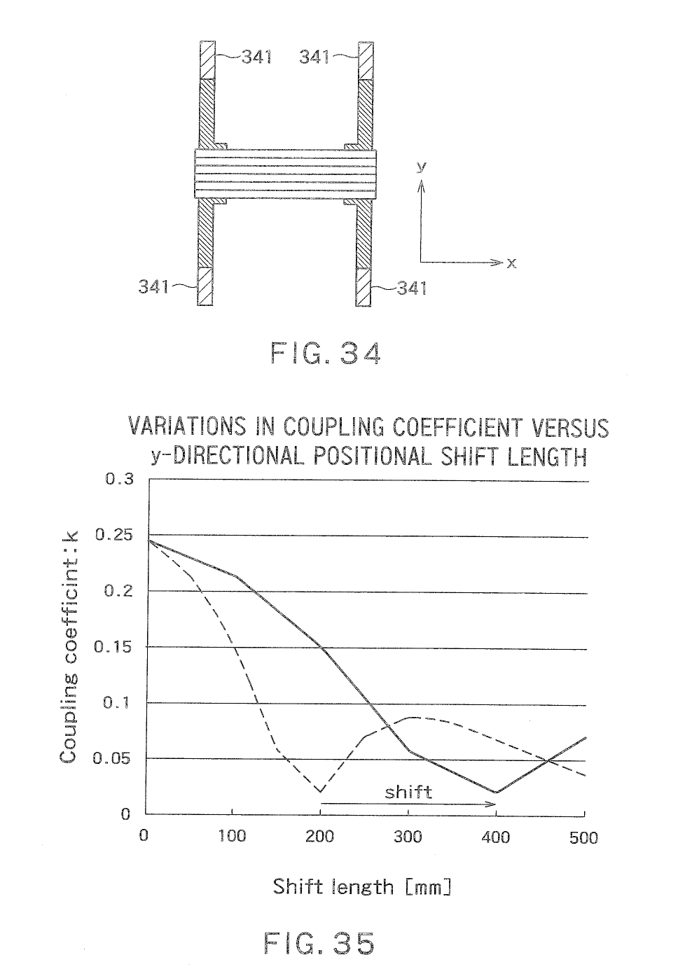

Accordingly, as indicated by 341 in FIG. 34, if the magnetic core block is elongated in the y-direction, as illustrated in FIG. 35, the position where the coupling coefficient decreases can be shifted much farther.

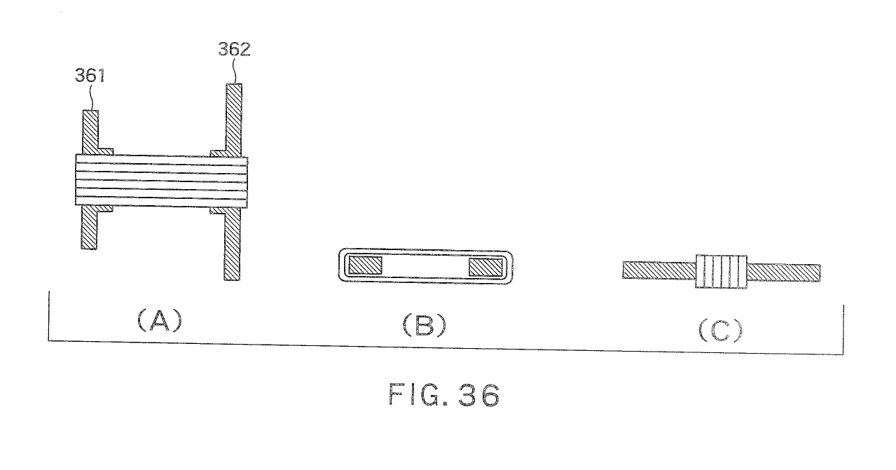

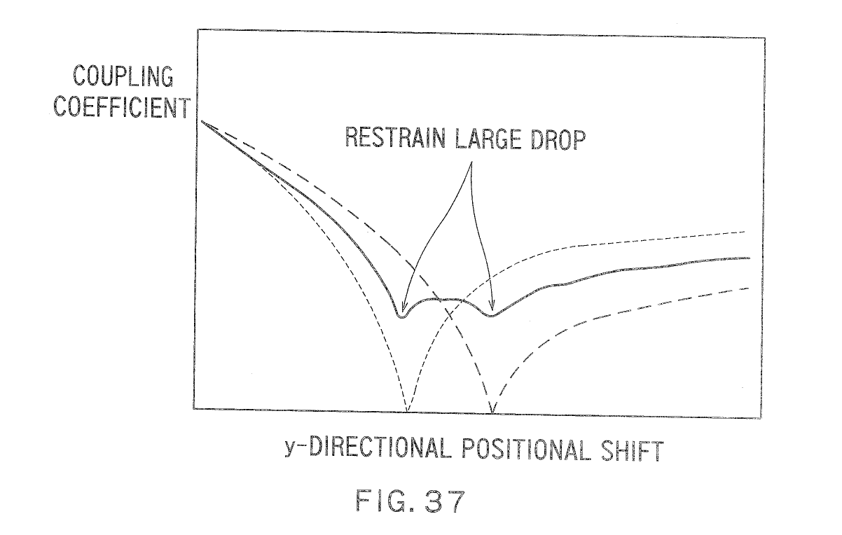

Moreover, if the lengths L_core of the magnetic core blocks 361, 362 at the right and left ends as in FIG. 36 are set to different values by use of the properties described above, as illustrated in FIG. 37, the decrease in coupling coefficient due to the cancellation of the magnetic fluxes occurs depending on the positional shifts corresponding to the respective lengths. However, it can be considered that a decrease quantity thereof can be restrained. Therefore, it can be considered that the large decrease in coupling coefficient can be restrained over the wide range of the positional shift.

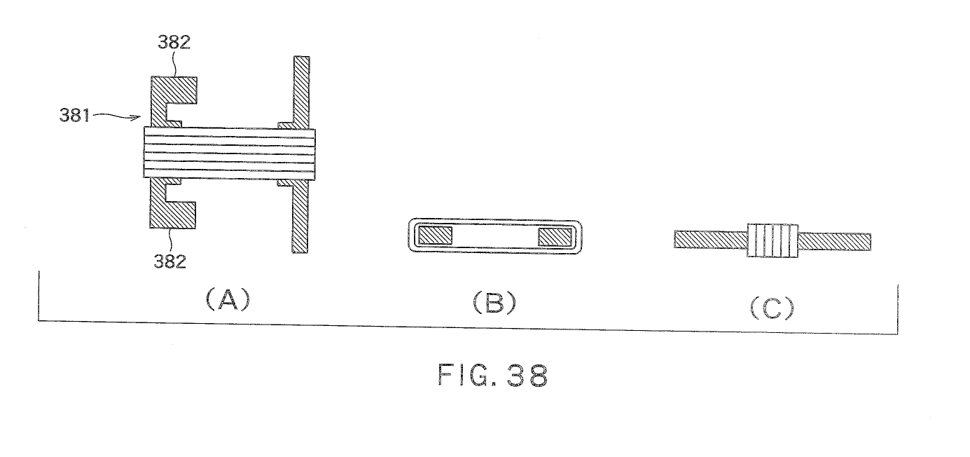

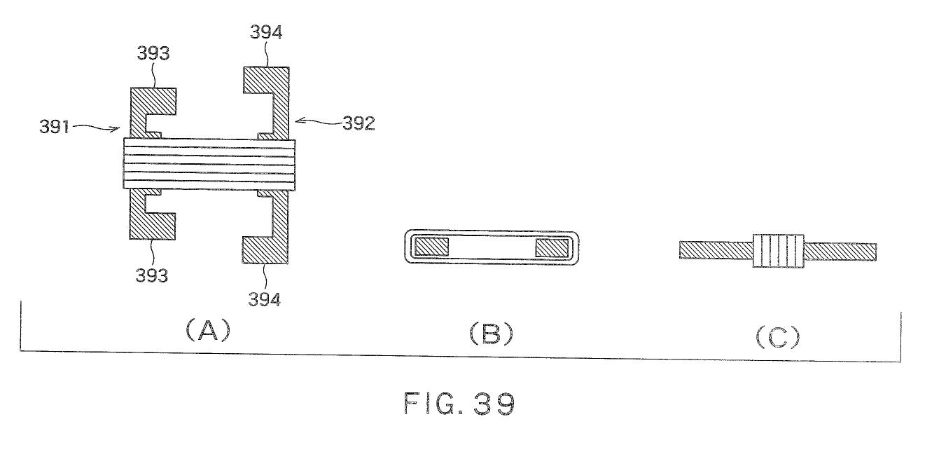

Further, as in FIG. 38, for instance, the shape of the magnetic core block may be changed by adding a fin 392 to a magnetic core block 381 having the short length L_core, or alternatively, as in FIG. 39, the shape of the magnetic core block may be changed by adding fins 393, 394 to both of right-and-left magnetic core blocks 391, 392. It can be thereby considered that the portions wound with none of the windings in the magnetic core blocks in the face-to-face relation are further elongated, the path of the magnetic flux loop is ensured further long, and the coupling coefficient between the upper and lower resonators is further increased.

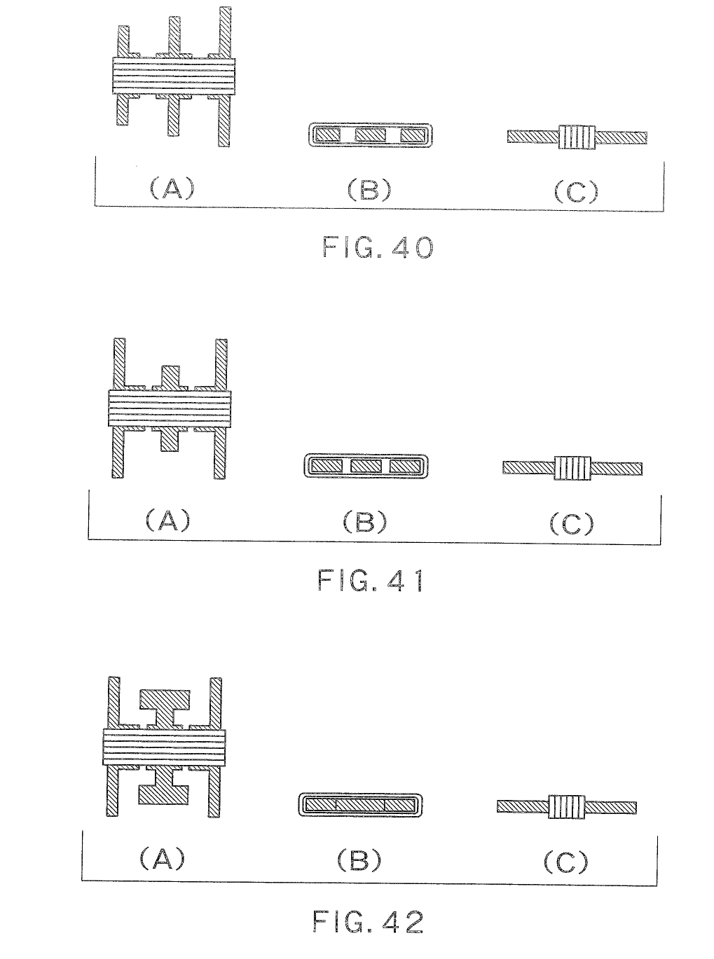

Moreover, as in FIGS. 40, 41, 42, the third magnetic core block is disposed at the portion including the center in the right-and-left directions of the coil, and at least two of the lengths of the three magnetic core blocks combined with the magnetic core blocks provided at the right and left ends are set to values different from each other, whereby the same effect as that shown in FIG. 37 can be acquired.

As discussed above, according to the embodiment of the present invention, it is feasible to provide the wireless power transmission device capable of reducing the weight of the resonator while increasing the power transmission efficiency. Furthermore, it is possible to provide the wireless power transmission device having the light weight and exhibiting the much higher efficiency by reducing the core loss.

It is to be noted that the embodiment discussed so far has described the configuration using the same type of resonators as the primary side resonator and the secondary side resonator, however, as a matter of course, a configuration using different types of resonators can be also considered.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A resonator comprising:
a magnetic core including a first magnetic core block and a second magnetic core block, the second magnetic core block being disposed at an interval from the first magnetic core block; and
a coil wound on the magnetic core in a lateral direction of the first and second magnetic core blocks,
wherein the first magnetic core block includes a first portion and second portions on sides of the first portion along a longitudinal direction of the first magnetic core block, and a sectional area of the first portion is larger than each sectional area of the second portions in a direction orthogonal to the longitudinal direction of the first magnetic core block,
wherein the second magnetic core block includes a third portion and fourth portions on sides of the third portion along the longitudinal direction of the second magnetic core block, and a sectional area of the third portion is larger than each sectional area of the fourth portions in a direction orthogonal to the longitudinal direction of the second magnetic core block, and
wherein the coil is wound on the first portion of the first magnetic core block and the third portion of the second magnetic core block.

2. The resonator according to claim 1, wherein a width of the first portion is wider than a width of the second portion in the lateral direction of the first magnetic core block, and
a width of the third portion is wider than a width of the fourth portion in the lateral direction of the second magnetic core block.

3. The resonator according to claim 1, wherein curvatures of the coil at positions adjacent to the first magnetic core block and the second magnetic core block are larger than those at other positions of the coil.

4. The resonator according to claim 1, wherein the second portion of the first magnetic core block has a smaller width or thickness as it gets closer to an end of the second portion in a side opposite to the first portion, and
the fourth portion of the second magnetic core block has a smaller width or thickness as it gets closer to an end of the fourth portion in a side opposite to the third portion.

5. The resonator according to claim 1, wherein the first portion of the first magnetic core block and the third portion of the second magnetic core block are formed as one body.

6. The resonator according to claim 1, wherein the magnetic core further includes a third magnetic core block between the first magnetic core block and the second magnetic core block,
the third magnetic core block includes a fifth portion and sixth portions on sides of the fifth portion along a longitudinal direction of the third magnetic core block, and a sectional area of the fifth portion is larger than each sectional area of the sixth portions in a direction orthogonal to the longitudinal direction of the third magnetic core block, and
the coil are wound on the first portion of the first magnetic core block, the third portion of the second magnetic core block and the fifth portion of the third magnetic core block.

7. The resonator according to claim 6, wherein the first portion, the third portion and the fifth portion are formed as one body.

8. The resonator according to claim 1, wherein the first magnetic core block includes a first extended portion having a larger width or thickness than the width or thickness of the second portion, and the first extended portion is provided on an end of the second portion in a side opposite to the first portion.

9. The resonator according to claim 1, wherein the second magnetic core block includes a second extended portion having a larger width or thickness than a width or thickness of the fourth portion, and the second extended portion is provided on an end of the fourth portion in a side opposite to the third portion.

10. The resonator according to claim 6, wherein the third magnetic core block includes a third extended portion having a larger width or thickness than a width or thickness of the sixth portion, and the third extended portion is provided on an end of the sixth portion in a side opposite to the fifth portion.

11. The resonator according to claim 1, wherein each length of portions wound with the coil of the first and second magnetic core blocks is equal to or smaller than ⅓ of a total length L_core of each of the first and second magnetic core blocks.

12. The resonator according to claim 1, wherein
a total length of one of the first magnetic core block and the second magnetic core block is shorter than that of the other of the first magnetic core block and the second magnetic core block.

13. The resonator according to claim 8, wherein
a total length of one of the first magnetic core block and the second magnetic core block is shorter than that of the other of the first magnetic core block and the second magnetic core block.

14. The resonator according to claim 9, wherein
a total length of one of the first magnetic core block and the second magnetic core block is shorter than that of the other of the first magnetic core block and the second magnetic core block.

15. The resonator according to claim 6, wherein
a total length of one of two of the first magnetic core block, the second magnetic core block and the third magnetic core block is shorter than that of the other of the two of the first magnetic core block and the second magnetic core block and the third magnetic core block.

16. The resonator according to claim 10, wherein
a total length of one of two of the first magnetic core block, the second magnetic core block and the third magnetic core block is shorter than that of the other of the two of the first magnetic core block and the second magnetic core block and the third magnetic core block.

17. The resonator according to claim 1, further comprising a first coil wound on the magnetic core in the lateral direction of the first and second magnetic core blocks, wherein
the first coil is wound on the first portion of the first magnetic core block and the third portion of the second magnetic core block, and
the first coil is arranged at a location separate from the first coil.

18. The resonator according to claim 4, further comprising a first coil wound on the magnetic core in the lateral direction of the first and second magnetic core blocks, wherein
the first coil is wound on the first portion of the first magnetic core block and the third portion of the second magnetic core block, and
the first coil is arranged at a location separate from the first coil.

19. A resonator comprising:
a magnetic core; and
a coil wound on the magnetic core in a first direction, wherein
the magnetic core includes a first portion on which the coil is wound, second portions, and third portions,
the second portions face each other across the first portion along a second direction different from the first direction, at one edges of the first portion,
the third portions face each other across the first portion along the second direction, at other edges of the first portion,
a sectional area of the first portion in the first direction is larger than each sectional area of the second portions in the first direction and larger than each sectional area of the third portions in the first direction.

20. A wireless power transmission device comprising:
a primary side resonator, according to claim 1, configured to receive an alternate current signal from an external power transmission circuit and to generate a magnetic field corresponding to the alternate current signal; and
a secondary side resonator, according to claim 1, configured to be disposed in a face-to-face relation with the primary side resonator and to receive the alternate current signal through magnetic coupling with the primary side resonator.
